(19) United States
(12) Patent Application Publication
(10) Pub. No.: US 2019/0258730 A1
(43) Pub. Date: Aug. 22, 2019

(54) TIME SLICING MASSIVE DATA PROCESSING

(71) Applicant: Beckman Coulter, Inc., Brea, CA (US)

(72) Inventors: Aleksandar Obradovic, Mission Viejo, CA (US); Kenny Tang, Irvine, CA (US)

(73) Assignee: Beckman Coulter, Inc., Brea, CA (US)

(21) Appl. No.: 15/902,358

(22) Filed: Feb. 22, 2018

(51) Int. Cl. G06F 17/30

(52) U.S. Cl. CPC G06F 17/30339; G06F 17/30377

(57) ABSTRACT

A method is disclosed. The method includes receiving, by one or more processors, a plurality of data values generated by one or more functional apparatuses. The processors group sets of data values from the plurality of data values. The processors, for each set of data values, determine a number of data values that pass a first predetermined threshold value, create a data point comprising the number of data values in the set of data values, a start time, and an end time, and store the data point when the number of data values in the data point pass a second predetermined threshold value. The processors analyze a group of data points created in step c) to determine if a total number of data values in the group of data points pass a criteria. The processors perform additional processing, if the total number of data values passes the criteria.

### CROSS-REFERENCES TO RELATED APPLICATIONS

None.

### BACKGROUND

Central computers that gather data from instruments such as a functional or chemical apparatuses receive and process raw data at high rates. In some cases, the central computers cannot keep up with the high rates and thus take large amounts of time to process the large sets of raw data. Long computation times are problematic when the received data values relate to potential system or instrument failures. It is difficult for the central computers to detect failures in a timely manner.

This problem is magnified when many remote instruments generate raw data and transmit the raw data to one or more central computers. The one or more central computers evaluate every single data value in the raw data from hundreds of remote instruments. Due to this, large amounts of time can pass between the remote instrument failing and the central computer determining that the system or remote instrument has failed. Further damage may occur as a result of these failures going unnoticed for long periods of time.

Additionally, current systems use hard coded rules to detect the condition of the remote instruments. This makes it difficult to use the one or more central computers with different types of remote instruments. Furthermore, if the remote instruments are replaced or upgraded, then the hard coded rules become obsolete.

Embodiments of the invention address these and other problems individually and collectively.

### BRIEF SUMMARY

Embodiments of the invention are directed to methods and systems of data processing.

One embodiment of the invention is directed to a method comprising: receiving, by one or more data processors, a plurality of data values generated by one or more functional apparatuses, the plurality of data values being ordered by a time when the data values in the plurality of data values were generated by the one or more functional apparatuses; grouping, by the one or more data processors, sets of data values from the plurality of data values using a data value time window; for each set of data values, (i) determining, by the one or more data processors, a number of data values in the set of data values that pass a first predetermined threshold value, (ii) creating a data point comprising the number of data values in the set of data values, and a start time associated with the data value time window, and an end time associated with the data value time window, (iii) storing, in an occurrence database, the data point when the number of data values in the data point pass a second predetermined threshold value; analyzing, by the one or more data processors, a group of data points created in step c) to determine if a total number of data values in the group of data points pass a criteria; and performing, by the one or more data processors, additional processing, if the total number of data values passes the criteria.

One embodiment of the invention is directed a system comprising one or more data processors; and one or more computer readable media coupled to the one or more processors, the one or more computer readable media comprising code executable by the one or more processors to perform a method comprising: receiving, a plurality of data values generated by one or more functional apparatuses, the plurality of data values being ordered by a time when the data values in the plurality of data values were generated by the one or more functional apparatuses; grouping, sets of data values from the plurality of data values using a data value time window; for each set of data values, (i) determining, a number of data values in the set of data values that pass a first predetermined threshold value, (ii) creating a data point comprising the number of data values in the set of data values, and a start time associated with the data value time window, and an end time associated with the data value time window, (iii) storing, in an occurrence database, the data point when the number of data values in the data point pass a second predetermined threshold value; analyzing, a group of data points created in step c) to determine if a total number of data values in the group of data points pass a criteria; and performing, additional processing, if the total number of data values passes the criteria.

Further details regarding embodiments of the invention can be found in the Detailed Description and the Figures.

### BRIEF DESCRIPTION OF THE DRAWINGS

FIG. 1 shows a block diagram of a system illustrating a data processing system according to embodiments of the present invention.

FIG. 2 shows a block diagram illustrating a time-slice computer according to an embodiment of the invention.

FIG. 3 shows a block diagram illustrating a data monitor computer according to an embodiment of the invention.

FIG. 4A shows a flow diagram illustrating a data processing method according to an embodiment of the invention.

FIG. 4B shows a flow diagram illustrating a data processing method according to an embodiment of the invention.

FIG. 5A shows a flow diagram illustrating an example process according to an embodiment of the invention.

FIG. 5B shows a flow diagram illustrating an example process according to an embodiment of the invention.

FIG. 5C shows a flow diagram illustrating an example process according to an embodiment of the invention.

FIG. 5D shows a flow diagram illustrating an example process according to an embodiment of the invention.

FIG. 5E shows a flow diagram illustrating an example process according to an embodiment of the invention.

FIG. 5F shows a flow diagram illustrating an example process according to an embodiment of the invention.

### DETAILED DESCRIPTION

Prior to discussing embodiments of the invention, some terms can be described in further detail.

A “device identifier” or “device ID” can be any identifier corresponding to a device. The device identifier can be in any suitable form and may include any suitable number of characters. A functional apparatus may be associated with a device identifier. Different functional apparatuses may be associated with different device identifiers.

A “functional apparatus” may be an apparatus that is functional. A functional apparatus may measure physical quantities. A functional apparatus may be in any suitable form. Examples of the functional apparatus may include server computers, laboratory instruments, measurement devices, thermometers, voltmeters, ammeters, wattmeters, chemical monitors (e.g., CO₂ monitors, etc.), hydrometers, heart rate monitors, etc. In some embodiments, a functional apparatus may refer to a measurement component coupled to a device, as well as the device as a whole.

A “physical quantity” may include distance, time, mass, temperature, amount of substance, electric current, voltage, density, power, luminous intensity, and angle. A physical quantity may be measured by a functional apparatus, resulting in a value based on the physical quantity. For example, a functional apparatus may be a server computer comprising a voltmeter, wherein the voltmeter may measure the voltage across a component of the server computer (e.g., a power supply, a processor, etc.) resulting in a value (e.g., 5 volts).

A “client device” may be any suitable device in communication with a data monitor computer. A client device may generally be located in any suitable location, such as near a functional apparatus. A client device may be in any suitable form. Some examples of client devices include cellular phones, smartphones, functional apparatuses, personal digital assistants (PDAs), personal computers (PCs), tablet PCs, server computers, hand-held specialized readers, set-top boxes, kiosks, security systems, access systems, notification systems, and the like. In embodiments, where the client device is a notification system or a server computer, the notification system and the server computer may include specially designed hardware and software for carrying out instructions from a data monitor computer. For example, software for tracking maintenance and repair of functional apparatuses.

As described herein, “pass a threshold value” may refer to either being “greater than or equal to the threshold value” or “less than or equal to the threshold value.” For example, a threshold value may be 10. If data values are typically measured to be below 10 (e.g., 8, 9, 7, 5, etc.) then a data value of 10 or 11 may pass the threshold value of 10. Further, if the data values are typically measured to be above 10 (e.g., 11, 12, 15, 14, etc.) then a data value of 10 or 9 may pass the threshold value of 10.

A “data value” may be a value of qualitative or quantitative variables. A data value may represent a physical quantity. For example, a data value may be a temperature data value of 25 degrees Celsius.

A “data value time window” may be an interval of time that includes one or more data values. A data value time window may be of any suitable length (e.g., 30 seconds, 5 minutes, 1 hour, etc.). A data value time window may be a range of time spanning from a start time to an end time. For example, a data value time window may be from “1:00 PM” to “1:05 PM.” In some embodiments, a data value time window may be associated with data values.

A “set of data values” may include data values within a data value time window. In some embodiments, sets of data values may be grouped from the plurality of data values using a data value time window. Any data values in the plurality of data values that were measured from “1:00 PM” to “1:05 PM” may be grouped into a set of data values.

A “data point” may be a discrete unit of information. A data point may be generally derived from a measurement or research. In some embodiments, a data point may be created by a time-slice computer. A data point may include information such as, for example, occurrences, a start time, and an end time. A data point can be created partially based on a set of data values. For example, an exemplary data point may include the following: 2 occurrences, a start time of “1:00 PM,” and an end time of “1:05 PM.”

A “data point time window” may be an interval of time that includes one or more data points. A data point time window may be of any suitable length (e.g., 30 seconds, 5 minutes, 1 hour, etc.). A data point time window may be a range of time spanning from a start time to an end time. For example, a data point time window may be from “1:00 PM” to “1:30 PM.” In some embodiments, a data point time window may be associated with data points. A data point time window may be generally longer than a data value time window.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

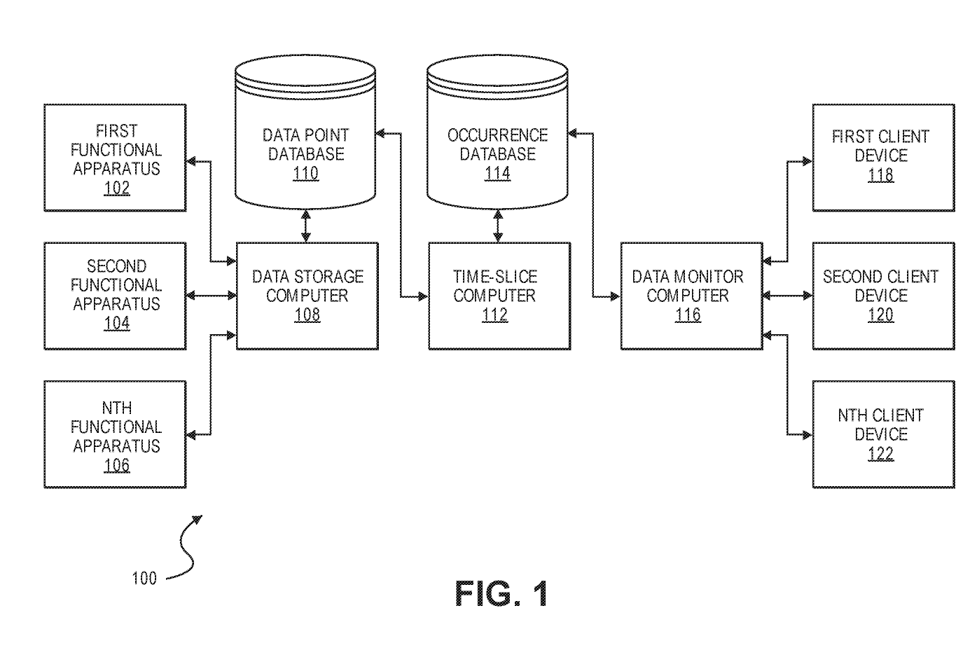

FIG. 1 shows a block diagram of a system 100 comprising a number of components according to some embodiments of the invention. The system 100 comprises a first functional apparatus 102, a second functional apparatus 104, an Nth functional apparatus 106, a data storage computer 108, a data point database 110, a time-slice computer 112, an occurrence database 114, a data monitor computer 116, a first client device 118, a second client device 120, and an Nth client device 122.

The first functional apparatus 102, the second functional apparatus 104, and the Nth functional apparatus 106 may be operatively connected to the data storage computer 108. The data storage computer 108 may be operatively connected to the data point database 110 which may be operatively connected to the time-slice computer 112. The time-slice computer 112 may be operatively connected to the occurrence database 114. Further, the occurrence database 114 may be operatively connected to the data monitor computer 116. The data monitor computer 116 may be operatively connected to the first client device 118, the second client device 120, and the Nth client device 122.

For simplicity of illustration, a certain number of components are shown in FIG. 1. It is understood, however, that embodiments of the invention may include more than one of each component.

The components in system 100 may be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The first functional apparatus 102, the second functional apparatus 104, and the Nth functional apparatus 106 may be capable of measuring physical quantities and outputting a value based on the physical quantity. The second functional apparatus 104 and the Nth functional apparatus 106 may have similar characteristics as the first functional apparatus 102. In some embodiments, the first functional apparatus 102 may be a server computer capable of measuring a voltage across a component of the server computer. In other embodiments, the first functional apparatus 102 may be a laboratory instrument capable of measuring various physical quantities of a chemical reaction (e.g., concentrations, reaction rates, etc.). In some embodiments, there may be one functional apparatus. In other embodiments, there may be two or more functional apparatuses.

In some embodiments, the first functional apparatus 102, the second functional apparatus 104, and the Nth functional apparatus 106 may be generally located at the same location. For example, the first functional apparatus 102, the second functional apparatus 104, and the Nth functional apparatus 106 may all be server computers or medical devices at a hospital.

In other embodiments, the first functional apparatus 102, the second functional apparatus 104, and the Nth functional apparatus 106 may be located at different locations. For example, the first functional apparatus 102, the second functional apparatus 104, and the Nth functional apparatus 106 may all be server computers or medical devices at different hospitals.

The data storage computer 108 may be a server computer capable of receiving a plurality of data values from the first functional apparatus 102. The data storage computer 108 may be capable of storing the plurality of data values in the data point database 110. The data storage computer 108 may be in communication with any number of functional apparatuses. For example, the data storage computer 108 may receive a plurality of data values from one hundred or more functional apparatuses.

In some embodiments, the data storage computer 108 may format the plurality of data values to ensure that they can be processed with other data values formatted in a similar manner. Any suitable format may be used. The data storage computer 108 may then store a plurality of formatted values.

The data point database 110 may be a conventional, fault tolerant, relational, scalable, secure database such as Oracle™ or Sybase™. The data point database 110 may be implemented using various standard data-structures, such as an array, hash, (linked) list, structured text file (e.g., XML), table, and/or the like. Such data-structures may be stored in memory and/or in (structured) files. The data point database 110 may be accessed by both the data storage computer 108 and the time-slice computer 112. In some embodiments, the data point database 110 may store data values. The data values may be stored in an order by a time when the data values in the plurality of data values were generated by the one or more functional apparatuses.

The time-slice computer 112 may be capable of obtaining data from the data point database 110, such as data values. The time-slice computer 112 may group sets of data values from the plurality of data values using a data value time window. In some embodiments, the time-slice computer 112 may be a server computer.

In other embodiments, the time-slice computer 112 can be capable of determining a number of data values in a set of data values that pass a first predetermined threshold value. The time-slice computer 112 can be capable of creating a data point comprising the number of data values in the set of data values, a start time, and an end time. The time-slice computer 112 may be capable of storing the data point when the number of data values in the data point pass a second predetermined threshold value.

The occurrence database 114 may be a conventional, fault tolerant, relational, scalable, secure database such as Oracle™ or Sybase™. The occurrence database 114 may be implemented using various standard data-structures, such as an array, hash, (linked) list, structured text file (e.g., XML), table, and/or the like. Such data-structures may be stored in memory and/or in (structured) files. The occurrence database 114 may be accessed by both the time-slice computer 112 and the data monitor computer 116. In some embodiments, the occurrence database 114 may store data points.

The occurrence database 114 may be configured to store data points, whereas the data point database 110 may be configured to store data values.

The data monitor computer 116 may be capable of obtaining data from the occurrence database 114, such as data points or groups of data points. In some embodiments, the data monitor computer 116 may be a server computer.

In some embodiments, the data monitor computer 116 may be capable of analyzing a group of data points, created by the time-slice computer 112, to determine if a total number of data values in the group of data points pass a criteria. For example, the group of data points may include four data points, wherein each data point may include a number of data values, a start time, and an end time. The first data point may be {5, 1:00, 1:10} wherein the first number is the number of data values, the second number is the start time, and the third number is the end time. The second data point may be {1, 1:10, 1:20}, the third data point may be {2, 1:20, 1:30}, and the fourth data point may be {1, 1:30, 1:40}. The data monitor computer 116 may add together the number of data values in each of the data points to determine the total number of data values, which in this example may be 5+1+2+1=9. Therefore, the total number of data values may be 9. The data monitor computer 116 may compare the total number of data values to a criteria, for example, a criteria of 7. In this example, the total number of data values pass the criteria. In other embodiments, the data monitor computer 116 may be capable of performing additional processing if the total number of data values passes the criteria. For example, if the total number of data values pass the criteria, then the data monitor computer 116 may transmit alert messages to one or more client devices, create a work order ticket, create a maintenance order, create a repair order, or call one or more client devices. The data monitor computer 116 may transmit an alert message stating that the total number of data values, 9, passed the criteria of 7.

The first client device 118, the second client device 120, and the Nth client device 122 may be in operative communication with the data monitor computer 116. In some embodiments, the first client device 118, the second client device 120, and the Nth client device 122 may be mobile devices capable of receiving messages and notifications from the data monitor computer 116.

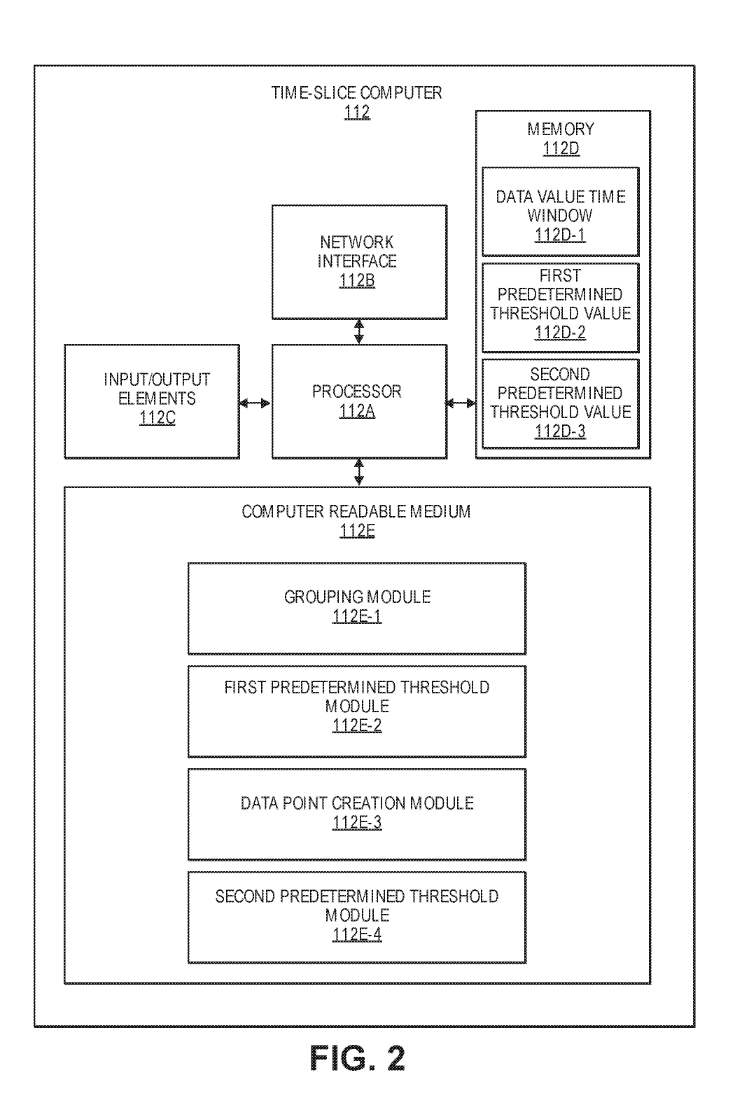

FIG. 2 shows a block diagram of a time-slice computer 112 according to an embodiment of the invention. The time-slice computer 112 may comprise a processor 112A, a network interface 112B, input/output elements 112C, a memory 112D including a data value time window 112D-1, a first predetermined threshold value 112D-2, and a second predetermined threshold value 112D-3, and a computer readable medium 112E comprising a grouping module 112E-1, a first predetermined threshold value module 112E-2, a data point creation module 112E-3, and a second predetermined threshold value module 112E-4.

The processor 112A may be operatively coupled to the network interface 112B, the input/output elements 112C, the memory 112D, and the computer readable medium 112E.

The network interface 112B may include an interface that can allow the time-slice computer 112 to communicate with external computers and databases. For example, the network interface 112B may comprise a contact, Bluetooth, or Wi-Fi interface. In some embodiments, the network interface 112B may be configured to allow secure transmissions between the time-slice computer 112 and the data point database 110 as well as the occurrence database 114.

The input/output elements 112C may comprise any suitable devices that may input/output data. Examples of output elements may include display screens, speakers, and data transmission devices. Examples of input elements may include buttons, touchscreens, touch pads, microphones, biometric scanners, etc.

The memory 112D may be coupled to the processor 112A. The memory 112D may be in the form of one or more memory devices (e.g., RAM, EEPROM, ROM chips), using any suitable mode of data storage. The memory 112D may include the data value time window 112D-1, the first predetermined threshold value 112D-2, and the second predetermined threshold value 112D-3. In some embodiments, the data value time window 112D-1, the first predetermined threshold value 112D-2, and the second predetermined threshold value 112D-3 may be stored in the memory 112D before the time-slice computer 112 receives a plurality of data values. In some embodiments, the data value time window 112D-1, the first predetermined threshold value 112D-2, and the second predetermined threshold value 112D-3 may be altered via input elements of the input/output elements 112C.

The computer readable medium 112E may comprise code, executable by the processor 112A. The computer readable medium 112E may comprise any number of applications, modules, and code. The computer readable medium 112E may comprise the grouping module 112E-1, the first predetermined threshold value module 112E-2, the data point creation module 112E-3, and the second predetermined threshold value module 112E-4. The computer readable medium 112E may comprise code, executable by the processor 112A for implementing a method comprising: receiving, by one or more data processors, a plurality of data values generated by one or more functional apparatuses, the plurality of data values being ordered by a time when the data values in the plurality of data values were generated by the one or more functional apparatuses; grouping, by one or more data processors, sets of data values from the plurality of data values using a data value time window; and for each set of data values, (i) determining, by one or more data processors, a number of data values in the set of data values that pass a first predetermined threshold value, (ii) creating a data point comprising the number of data values in the set of data values, and a start time associated with the data value time window, and an end time associated with the data value time window, and (iii) storing, in an occurrence database, the data point when the number of data values in the data point pass a second predetermined threshold value.

The grouping module 112E-1 may group sets of data values from a plurality of data values using the data value time window from the memory 112D. The plurality of data values may be received by the time-slice computer 112 from the data point database 110. In some embodiments, the data values in the plurality of data values may each be associated with a generation time. The generation time may be a time that the data value was generated by the functional apparatus. The grouping module 112E-1 may analyze the generation time, and determine if the generation time is within the bounds of the data value time window. For example, the generation times for three data values of the plurality of data values may be 9:01 AM, 9:02 AM, and 9:03 AM. If the data value time window is 9:00 AM to 9:05 AM (5 minutes), the grouping module 112E-1 may group these three data values of the plurality of data values into a set of data values.

In some embodiments, each of the functional apparatuses may be associated with a device identifier. The time-slice computer 112, when receiving the plurality of data values, may also receive the device identifier for each functional apparatus associated with the received data values. The grouping module 112E-1 may group the sets of data values using the data value time window as well as the device identifier. In some embodiments, the grouping module 112E-1 may group more than one set of data values from the plurality of data values. In other embodiments, the grouping module 112E-1 may parse the plurality of data values using the data value time window and the device identifier. For example, the time-slice computer 112 may receive device identifiers from the first functional apparatus 102 and the second functional apparatus 104. The grouping module 112E-1 may use the data value time window, as described above, and then the grouping module 112E-1 may separate the data values based on the device identifiers into two data sets. The first data set contains data values within the data value time window and is associated with the first functional apparatus 102. The second data set contains data values within the data value time window and is associated with the second functional apparatus 104. The grouping module 112E-1 may group any number of sets of data values.

The first predetermined threshold value module 112E-2 may, for each set of data values, determine a number of data values in the set of data values that pass a first predetermined threshold value. In some embodiments, the first predetermined threshold value module 112E-2 may access the first predetermined threshold value in the memory 112D. The first predetermined threshold value module 112E-2 may, in conjunction processor 112A, compare the number of data values in the set of data values to the first predetermined threshold value. For example, if the set of data values included the five data values of “98,” “99,” “95,” “101,” and “97,” and the first predetermined threshold value was equal to 100, then the first predetermined threshold value module 112E-2 may compare each of the data values in the set of data values to the first predetermined threshold value. In this case, the first predetermined threshold value module 112E-2 may determine that 1 of the 5 data values in the set of data values passes the first predetermined threshold value of 100.

In some embodiments, the first predetermined threshold value module 112E-2 may, in conjunction with the processor 112A, determine the number of data values in the set of data values that pass a first predetermined threshold value, for more than one set of data values. For example, the grouping module 112E-1 may have grouped three sets of data values from the plurality of data values, wherein the three sets of data values are a first set of data values associated with the first functional apparatus 102, a second set of data values associated with the second functional apparatus 104, and a third set of data values associated with a third functional apparatus. The first predetermined threshold value module 112E-2 may, in conjunction with determine the number of data values in the first set of data values that pass the first predetermined threshold value, the number of data values in the second set of data values that pass the first predetermined threshold value, and the number of data values in the third set of data values that pass the first predetermined threshold value.

The data point creation module 112E-3 may, in conjunction with processor 112A, create a data point comprising the number of data values in the set of data values, a start time associated with the data value time window, and an end time associated with the data value time window. In some embodiments, the start time may be the start time of the data value time window, and the end time may be the end time of the data value time window.

In other embodiments, the data point creation module 112E-3, in conjunction with processor 112A, may create a data point for each set of data values that were grouped by the grouping module 112E-1. The data point creation module 112E-3 may receive the number of data values in the set of data values from the first predetermined threshold value module 112E-2 after the first predetermined threshold value module 112E-2 determines the number of data values in the set of data values that pass the first predetermined threshold value. For example, if there are three functional apparatuses and three device identifiers, then the data point creation module 112E-3 may create three data points, wherein each data point is associated with the device identifier.

The second predetermined threshold value module 112E-4 may, in conjunction with processor 112A, store, in the occurrence database 114, the data point when the number of data values in the data point pass a second predetermined threshold value. In some embodiments, the second predetermined threshold value module 112E-4 may access the second predetermined threshold value in the memory 112D.

The second predetermined threshold value module 112E-4 may, in conjunction with processor 112A, compare the number of data values in the data point to the second predetermined threshold value. For example, if the number of data values in the data point is 3 (meaning 3 data values passed the first predetermined threshold value) and the second predetermined threshold value is equal to 1, then the second predetermined threshold value module 112E-4 may determine that the number of data values in the data point pass the second predetermined threshold value.

After determining that the number of data values in the data point pass the second predetermined threshold value, the second predetermined threshold value module 112E-4 may store the data point in the occurrence database 114.

In some embodiments, if the second predetermined threshold value module 112E-4 determines that the number of data values in the data point does not pass the second predetermined threshold value, then the second predetermined threshold value module 112E-4 may decide not to store the data point in the occurrence database 114. In some embodiments, after not storing the data point, the second predetermined threshold value module 112E-4 may delete the data point. In other embodiments, the second predetermined threshold value module 112E-4 may log that the data point did not pass the second predetermined threshold value, which may include storing the data point in a memory.

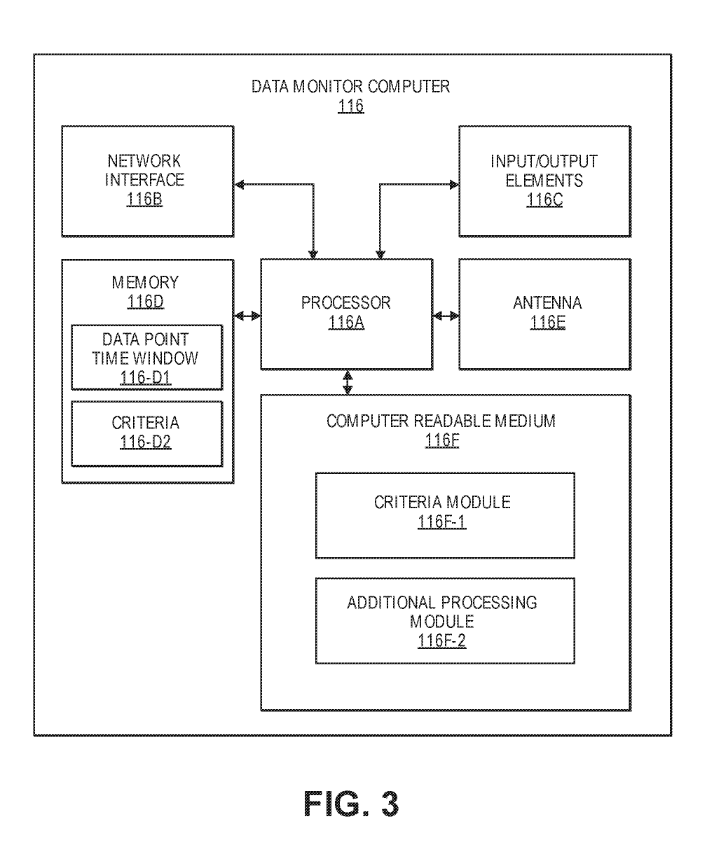

FIG. 3 shows a block diagram of a data monitor computer 116 according to an embodiment of the invention. The data monitor computer 116 may comprise a processor 116A, a network interface 116B, input/output elements 116C, a memory 116D including a data point time window 116D-1 and a criteria 116D-2, an antenna 116E, and a computer readable medium 116F comprising a criteria module 116F-1 and an additional processing module 116F-2.

The network interface 116B may have characteristics similar to the network interface 112B, and the descriptions thereof need not be repeated. In some embodiments, the network interface 116B may be configured to allow secure transmissions between the data monitor computer 116 and the occurrence database 114 as well as client devices (118-122).

The input/output elements 116C may have characteristics similar to the input/output elements 112C, and the descriptions thereof need not be repeated.

The memory 116D may be coupled to the processor 116A. The memory 116D may have similar characteristics to the memory 112D, and the descriptions thereof need not be repeated.

The antenna 116E may be used to provide the data monitor computer 116 with long range communication capabilities, over the air.

The computer readable medium 116F may comprise code, executable by the processor 116A. The computer readable medium 116F may comprise any number of applications, modules, and code. The computer readable medium 116F may comprise the criteria module 116F-1 and the additional processing module 116F-2. The computer readable medium 116F may comprise code, executable by the processor 116A for implementing a method comprising: analyzing, by one or more data processors, a group of data points created in step c) to determine if a total number of data values in the group of data points pass a criteria 116D-2; and performing, by one or more data processors, additional processing, if the total number of data values passes the criteria 116D-2.

The criteria module 116F-1 may analyze, in conjunction with the processor 116A, a group of data points, created by the data point creation module 112E-3 and stored by the second predetermined threshold value module 112E-4, to determine if a total number of data values in the group of data points passes a criteria 116D-2. In some embodiments, the criteria module 116F-1 may access the criteria 116D-2 and the data point time window 116D-1 in the memory 116D. The data points in the group of data points may include a start time and an end time that is within the data point time window 116D-1. In some embodiments, the data monitor computer 116 may group the data points into the group of data points using the data point time window 116D-1.

In some embodiments, the criteria module 116F-1 may add together the number of data values that pass the first predetermined threshold value from each data point to determine the total number of data values. For example, a first data point may include the number of data values of 2, a second data point may include the number of data values of 1, and a third data point may include the number of data values of 3. The criteria module 116F-1 may determine that the total number of data values in the group of data points, in this example, is 6. The criteria module 116F-1 may then compare the total number of data values to the criteria 116D-2. For example, the criteria 116D-2 may be “5 data values in a 10 minute period.” The criteria module 116F-1 may determine that the total number of data values in the group of data points, 6, passes the criteria 116D-2, 5, for the data point time window 116D-1 of 10 minutes.

The additional processing module 116F-2 may perform additional processing if the total number of data values passes the criteria 116D-2. In some embodiments, the additional processing may include the data monitor computer 116 communicating with the first client device 118, the second client device 120, and the Nth client device 122. In other embodiments, additional processing may comprise transmitting alert messages to one or more client devices, creating a work order ticket, creating a maintenance order, creating a repair order, and calling one or more client devices. In some embodiments, the one or more client devices may be the one or more functional apparatuses. The additional processing may comprise shutting down one or more functional apparatuses, changing the data measurement rat of one or more functional apparatuses, and changing parameters of one or more functional apparatuses. Additional processing is discussed in further detail below.

In some embodiments, the criteria module 116F-1 may determine that the total number of data values in the group of data points does not pass the criteria 116D-2. In this case, the additional processing module 116F-2 may determine not to perform additional processing.

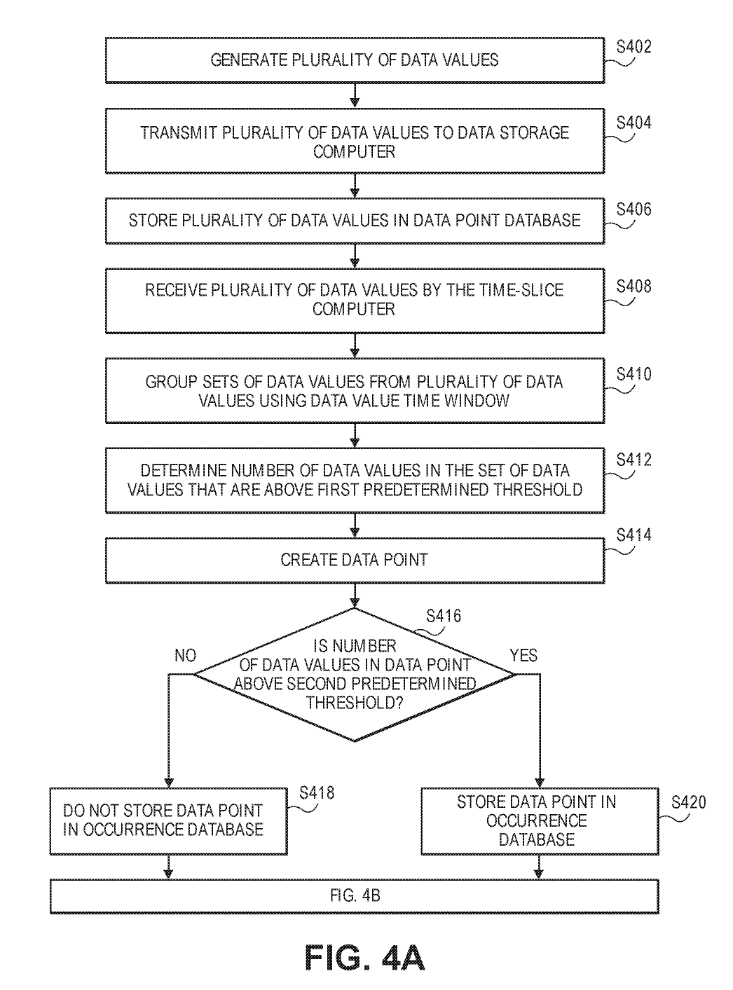

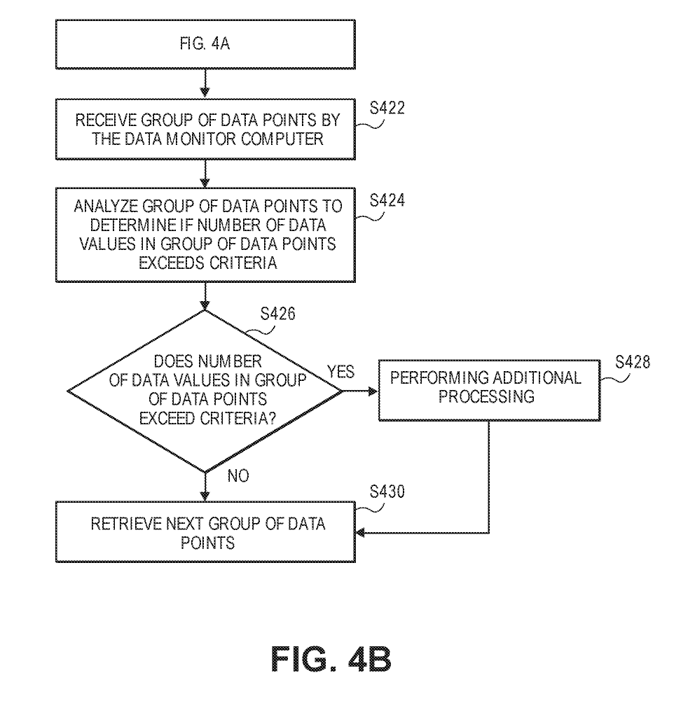

FIG. 4A shows a flow diagram illustrating a data processing method according to an embodiment of the invention. The method illustrated in FIG. 4 will be described in the context of data values related to voltage readings. It is understood, however, that the invention can be applied to other circumstances (e.g., temperature readings, current readings, power readings, chemical readings, density readings, etc.) in which the ability to perform data processing is needed. Although the steps are illustrated in a specific order, it is understood that embodiments of the invention may include methods that have the steps in different orders. In addition, steps may be omitted or added and may still be within embodiments of the invention.

Step S402 may occur when the first functional apparatus 102, the second functional apparatus 104, and the Nth functional apparatus 106 start measuring physical quantities. For example, each functional apparatus may be a voltmeter coupled to a server computer, and may measure a voltage across a specific part of the server computer, such as a power supply. The power supply may fail when the voltage drops below 10 volts.

At step S402, the first functional apparatus 102, the second functional apparatus 104, and the Nth functional apparatus 106 may generate a plurality of data values. In some embodiments, each of the functional apparatuses may generate a data value from measuring a voltage. For example, the first functional apparatus 102 may generate the plurality of data values including a first data value of 10.6 volts, a second data value of 11.0 volts, a third data value of 10.8 volts, and a fourth data value of 10.1 volts. The first, second, third, and fourth data values may make up the plurality of data values. In some embodiments, there may be any number of data values in the plurality of data values.

In other embodiments, the plurality of data values may be generated one data value at a time. The first functional apparatus 102 may generate the data values of the plurality of data values at any specified rate and at any specified time.

In some embodiments, each data value of the plurality of data values may be associated with a time that the data value was measured by the first functional apparatus 102. For example, the first data value of 10.6 volts may be associated with the time of “1:00 PM.” The time may be in any suitable format. In other embodiments, each data value of the plurality of data values may be associated with the device identifier associated with the functional apparatus. For example, the first data value of 10.6 volts may be associated with the device identifier of x07a17hm3829uk11d.

At step S404, the first functional apparatus 102 may transmit the plurality of data values to the data storage computer 108. In some embodiments, the first functional apparatus 102 may transmit one data value at a time to the data storage computer 108. In other embodiments, the first functional apparatus 102 may transmit the plurality of data values after a predetermined amount of time. For example, the first functional apparatus 102 may transmit the plurality of data values to the data storage computer 108 every five minutes. In yet other embodiments, the first functional apparatus 102 may transmit the plurality of data values to the data storage computer 108 once a predetermined number of data values have been recorded, for example, the first functional apparatus 102 may transmit data values to the data storage computer 108 after six data values have been recorded.

In some embodiments, the first functional apparatus 102 may transmit the device identifier associated with the first functional apparatus 102 to the data storage computer 108. The device identifier may be different for each functional apparatus. In some embodiments, the data storage computer 108 may assign the device identifier to each functional apparatus. In other embodiments, the device identifier may be predetermined.

At step S406, after receiving the plurality of data values, the data storage computer 108 may store the plurality of data values in the data point database 110. In some embodiments, the data storage computer 108 may store the plurality of data values in association with the device identifier of the functional apparatus that the plurality of data values originated from.

In other embodiments, the plurality of data values may be ordered by a time when the data values in the plurality of data values were generated by the first functional apparatus 102. In other words, the data values may be arranged in chronological order.

At step S408, the time-slice computer 112 may receive the plurality of data values from the data point database 110. In some embodiments, the time-slice computer 112 may retrieve the plurality of data values from the data point database 110.

The time-slice computer 112 may receive the plurality of data values after a previous plurality of data values has been processed. For example, the time-slice computer 112 may receive the plurality of data values associated with a data value time window of 12:00 PM to 12:05 PM. After the time-slice computer 112 has finished processing the plurality of data values, the time-slice computer 112 may receive the plurality of data values associated with a data value time window of 12:05 PM to 12:10 PM.

At step S410, the time-slice computer 112 may group sets of data values from the plurality of data values using a data value time window. The data value time window may be associated with the time that the data value was measured by the first functional apparatus 102. The data value time window may be a range of time spanning from a start time to an end time, wherein the start time may be an earliest time that the data value was measured, and wherein the end time may be a latest time that the data value was measured. In other embodiments, the data value time window may be a predetermined range of time. For example, the time-slice computer 112 may receive the plurality of data values 10.6 volts, 11.0 volts, 10.8 volts, and 10.1 volts in the data value time window of “12:00 PM” to “12:05 PM.”

In some embodiments, any number of data values of the plurality of data values may be grouped into the set of data values. In other embodiments, grouping sets of data values from the plurality of data values using a data value time window may include determining, by the time-slice computer 112, which data values of the plurality of data values include start times and/or end times within the data value time window.

In other embodiments, the time-slice computer 112, when receiving the plurality of data values, may also receive the device identifier for each functional apparatus associated with the received data values. The time-slice computer 112 may group the sets of data values using the data value time window as well as the device identifier.

In some embodiments, the time-slice computer 112 may group more than one set of data values from the plurality of data values. For example, the time-slice computer 112 may receive device identifiers from the first functional apparatus 102 and the second functional apparatus 104. The time-slice computer 112 may use the data value time window, as described above, then the time-slice computer 112 may separate the data values based on the device identifiers into two data sets. The first data set containing data values within the data value time window and associated with the first functional apparatus 102. The second data set containing data values within the data value time window and associated with the second functional apparatus 104. The time-slice computer 112 may group any number of sets of data values.

In other embodiments, the data values of the plurality of data values may be associated with a device identifier. A set of data values of the sets of data values may include data values associated with a single device identifier. The time-slice computer 112 may group the data values into the set of data values based on the device identifier associated with the data values. That is, the set of data values may be associated with a single device identifier. For example, the set of data values may result from one functional apparatus. This may allow users to examine the functional apparatus, such as determining if there are a certain number of voltage drops in the functional apparatus.

In yet other embodiments, a set of data values of the sets of data values may include data values associated with many device identifiers. The time-slice computer 112 may group the data values into the set of data values regardless of the device identifier associated with the data values. That is, the set of data values may be associated with many device identifiers. For example, the set of data values may result from the functional apparatuses of a hospital. This may allow users of the system to examine the hospital's functional apparatuses as a whole, such as determining if there are a certain number of voltage drops in the hospital regardless of which functional device measured the voltage drop.

At step S412, after grouping the sets of data values, the time-slice computer 112 may determine a number of data values in the set of data values that pass a first predetermined threshold value resulting in a number of data values. The first predetermined threshold value may be predetermined by an entity associated with the time-slice computer 112. The number of data values that pass the first predetermined threshold value may be referred to as “occurrences.”

In some embodiments, the first predetermined threshold value may correspond to a value related to the first functional apparatus 102. For example, the first functional apparatus 102 may be a voltmeter coupled to a server computer, wherein the power supply of the server computer may fail at a voltage under 10 volts. The first predetermined threshold value may be predetermined to be 10.1 volts. In order to pass the first predetermined threshold value of 10 volts, a data value may be less than or equal to 10 volts.

In some embodiments, the time-slice computer 112 may determine a number of data values in the set of data values that pass the first predetermined threshold value for each set of data values. For example, the time-slice computer 112 may have grouped three sets of data values from the plurality of data values, wherein the three sets of data values are a first set of data values associated with the first functional apparatus 102, a second set of data values associated with the second functional apparatus 104, and a third set of data values associated with a third functional apparatus. The time-slice computer 112 may determine the number of data values in the first set of data values that pass the first predetermined threshold value, the number of data values in the second set of data values that pass the first predetermined threshold value, and the number of data values in the third set of data values that pass the first predetermined threshold value.

In some embodiments, determining a number of data values in the set of data values that pass the first predetermined threshold value may include the time-slice computer 112 comparing the number of data values in the set of data values to the first predetermined threshold value.

At step S414, after determining the number of data values in the set of data values that pass the first predetermined threshold value, the time-slice computer 112 may create a data point comprising a number of data values that pass the first predetermined threshold value, a start time associated with the data value time window, and an end time associated with the data value time window. In some embodiments, the start time may be the start time of the data value time window, and the end time may be the end time of the data value time window.

In some embodiments, the time-slice computer 112 may create a data point for each set of data values that has been determined to have a number of data values that pass the first predetermined threshold value. For example, if there are three functional apparatuses and three device identifiers, then the time-slice computer 112 may create three data points, wherein each data point is associated with the device identifier.

At step S416, after creating the data point, the time-slice computer 112 may determine if the number of data values in the data point pass a second predetermined threshold value. The second predetermined threshold value may be predetermined by an entity associated with the time-slice computer 112. The second predetermined threshold value may be a minimum number of occurrences within the data value time window in order to store the data point.

In some embodiments, determining if the number of data values in the data point pass the second predetermined threshold value may include comparing, by the time-slice computer 112, the number of data values in the data point to the second predetermined threshold value. For example, if the number of data values in the data point is 3 (meaning 3 data values passed the first predetermined threshold value) and the second predetermined threshold value is equal to 1, then the time-slice computer 112 may compare the two numbers and then may determine that the number of data values in the data point pass the second predetermined threshold value.

At step S418, the time-slice computer 112 may determine not to store the data point in the occurrence database 114 when the number of data values in the data point does not pass a second predetermined threshold value. For example, the second predetermined threshold value may be a value of 3. If there is only 1 data value passed the voltage of 10.1 volts in a set of data values, then the data point will not be stored.

In some embodiments, after not storing the data point, the time-slice computer 112 may delete the data point. In other embodiments, the time-slice computer 112 may log that the data point did not pass the second predetermined threshold value, which may include storing the data point in a memory.

At step S420, the time-slice computer 112 may decide to store the data point in the occurrence database 114 when the number of data values in the data point pass a second predetermined threshold value. For example, if the second predetermined threshold value is 3, and there are 4 data values passed (i.e., less than or equal to) the voltage of 10.1 volts in a set of data values, then the data point will be stored. The time-slice computer 112 may store the data point in the occurrence database 114.

In some embodiments, the second predetermined threshold value may be used to cut down on random error in the measurements taken by the functional apparatuses. For example, the first functional apparatus 102 may have an error associated with its measurements (e.g., a data value of 10.09±0.02 volts). In this case the data value is passed the first threshold, but its error makes it unclear if it should actually be counted as such. The second predetermined threshold may mitigate some of the random errors introduced by the functional apparatuses.

FIG. 4B shows a flow diagram illustrating a data processing method according to an embodiment of the invention. The process in FIG. 4B may continue from FIG. 4A.

At step S422, after the time-slice computer 112 stores the data point in the occurrence database 114, the data monitor computer 116 may receive a group of data points from the occurrence database 114. The group of data points may contain any number of data points.

In some embodiments, the group of data points may be received with respect to a data point time window. The data monitor computer 116 may receive all of the data points in the data point time window. For example, the group of data points may contain data points with start times and end times within the data point time window. For example, the data point time window may be 30 minutes. The data monitor computer 116 may receive the group of data points within a 30 minute period, for example, 2:00 PM to 2:30 PM.

In some embodiments, the data monitor computer 116 may determine the data point time window. In other embodiments, the data point time window may be predetermined by an entity associated with the data monitor computer 116.

At step S424, after receiving the group of data points, the data monitor computer 116 may analyze the group of data points to determine if a total number of data values in the group of data points passes a criteria. The criteria may be a value predetermined by an entity associated with the data monitor computer 116.

In some embodiments, the group of data points may be referred to as summarized data. The summarized data may be smaller, in terms of data size, than the size of the plurality of data values. In some embodiments, evaluating the summarized data may be more efficient than evaluating every data value, since there is a smaller amount of data to evaluate. For example, if the functional apparatuses generated 5000 data values, the data monitor computer 116 may not have to evaluate all 5000 data values as in previous methods and systems. The number of data points created by the time-slice computer 112 may be less than 5000. The data monitor computer 116 may be able to efficiently evaluate the created data points.

In some embodiments, the data monitor computer 116 may group the data points into the group of data points using the data point time window. The data monitor computer 116 may determine if a data point comprises the start time and the end time that are within the data point time window. If the start time and the end time are within the data point time window, the data monitor computer 116 may include that data point into the group of data points.

At step S426, the data monitor computer 116 may determine if the number of data values in the group of data points passes the criteria, based on the above analysis.

In some embodiments, the data monitor computer 116 may add together the number of data values that pass the first predetermined threshold value from each data point to determine the total number of data values. For example, a first data point may include the number of data values of 2, a second data point may include the number of data values of 1, and a third data point may include the number of data values of 3. The data monitor computer 116 may determine that the total number of data values in the group of data points, in this example, is 6. The data monitor computer 116 may then compare the total number of data values to the criteria. For example, the criteria may be “5 data points in a 10 minute period.” The data monitor computer 116 may determine that the total number of data values in the group of data points, 6, passes the criteria, 5, for the data point time window of 10 minutes.

At step S428, if the data monitor computer 116 determines that the total number of data values in the group of data points pass the criteria then the data monitor computer 116 may perform additional processing. For example, if the total number of data values in the group of data points is 3 and passes the criteria of 2, then the data monitor computer 116 may perform additional processing.

In some embodiments, the data monitor computer 116 may determine the device identifier associated with the data points of the group of data points. The data monitor computer 116 may then determine the functional apparatus that the group of data points is associated with. In some embodiments, the data monitor computer may perform additional processing based on the associated functional apparatus.

Additional processing may comprise transmitting alert messages to one or more client devices, for example, the first client device 118. In some embodiments, the alert message may contain information relating to the determination that the number of data values in the group of data points passed the criteria. For example, the data monitor computer 116 may transmit a message via short message service (SMS) or multimedia messaging service (MMS) to a smart phone, wherein the message indicates that the first functional apparatus 102 may be close to failure since it reached unsafe voltages 3 times in the past thirty minutes.

In some embodiments, additional processing may comprise creating a work order, a maintenance order, or a repair order. For example, the data monitor computer 116 may transmit a message to a server computer requesting the creation of a work order. The message may contain information about the criteria being passed.

In other embodiments, additional processing may comprise sending an email. The data monitor computer 116 may transmit emails to predetermined addresses.

In yet other embodiments, additional processing may comprise calling a cellular device. For example, the data monitor computer 116 may call a cellular device and play a prerecorded message.

In some embodiments, additional processing may comprise communicating with one or more functional apparatuses if the one or more client devices are the one or more functional apparatuses. Communicating with one or more functional apparatuses may include shutting down that functional apparatus, changing the data measurement rate of the functional apparatus, and changing parameters of the functional apparatus. For example, the first client device 118 may be the first functional apparatus 102. The data monitor computer 116 may have determined that the first functional apparatus 102 reached unsafe voltages 4 times in the past 15 minutes. The data monitor computer 116 may then shutdown the first functional apparatus 102, or otherwise place the first functional apparatus 102 in a safe mode.

In some embodiments changing parameters of the functional apparatus may include parameters such as power consumption, voltage levels, safety modes, and other parameters relating to that specific functional apparatus.

In some embodiments, additional processing may comprise any combination of the above additional processing techniques.

At step S430, if the data monitor computer 116 determines that the number of data values in the group of data points does not pass the criteria then the data monitor computer 116 may receive a next group of data points from the occurrence database 114 if there is a next group of data points stored in the occurrence database 114. For example, if the data monitor computer 116 finished analyzing the data points from 2:00 PM to 2:30 PM, the data monitor computer 116 may then receive the group of data points in the next data point time window, which, in this cases, may be 2:05 PM to 2:35 PM. In some embodiments, a consecutive data point time window may be separated by the length of time of the data value time window.

Step S430 may also occur after step S428, after the data monitor computer 116 performs additional processing. For example, after the data monitor computer 116 transmits an email to the first client device 118, the data monitor computer 116 may receive the next group of data points.

In some embodiments, the first predetermined threshold value, the second predetermined threshold value, the criteria, the data value time window, and the data point time window may all be variables that may be varied by an entity associated with the time-slice computer 112 and/or the data monitor computer 116.

In some embodiments, the steps above may be performed by one or more processors. A system may include one or more data processors and one or more computer readable media coupled to the one or more processors, the one or more computer readable media comprising code executable by the one or more processors to perform the method comprising: a) receiving, a plurality of data values generated by one or more functional apparatuses, the plurality of data values being ordered by a time when the data values in the plurality of data values were generated by the one or more functional apparatuses; b) grouping, sets of data values from the plurality of data values using a data value time window; c) for each set of data values, (i) determining, a number of data values in the set of data values that pass a first predetermined threshold value, (ii) creating a data point comprising the number of data values in the set of data values, and a start time associated with the data value time window, and an end time associated with the data value time window, (iii) storing, in an occurrence database, the data point when the number of data values in the data point pass a second predetermined threshold value; d) analyzing, a group of data points created in step c) to determine if a total number of data values in the group of data points pass a criteria; and e) performing, additional processing, if the total number of data values passes the criteria.

In some embodiments, the one or more processors may be the processor 112A of the time-slice computer 112 and the processor 116A of the data monitor computer 116. In other embodiments method above, may be performed wherein steps a), b), and c) are performed by a first processor in a time-slice computer, and steps d), and e) are performed by a second processor in a data monitor computer.

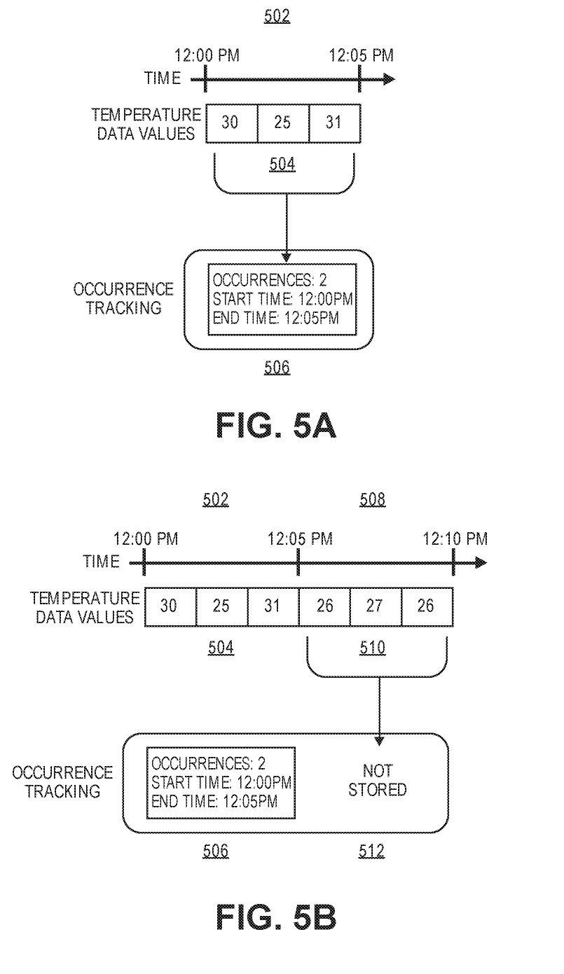

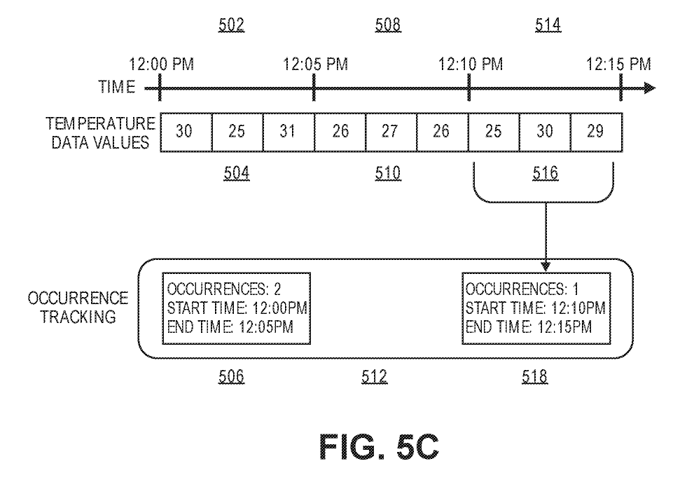

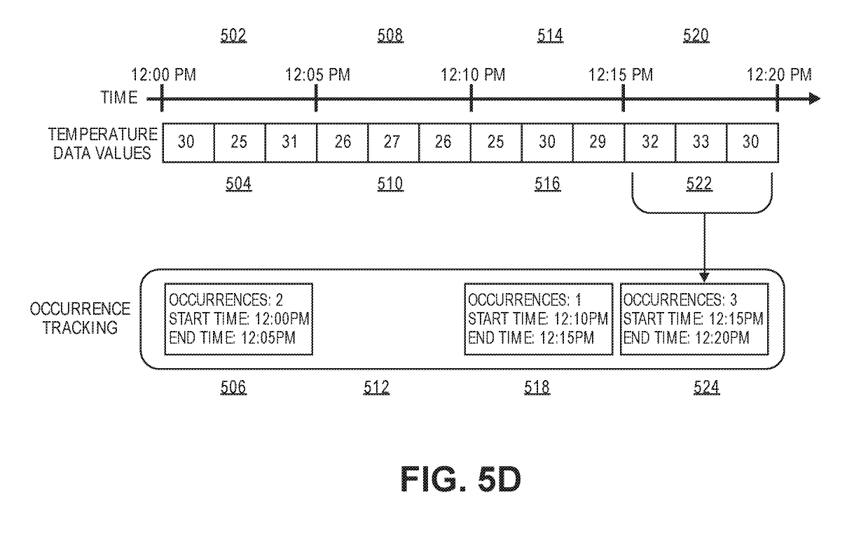

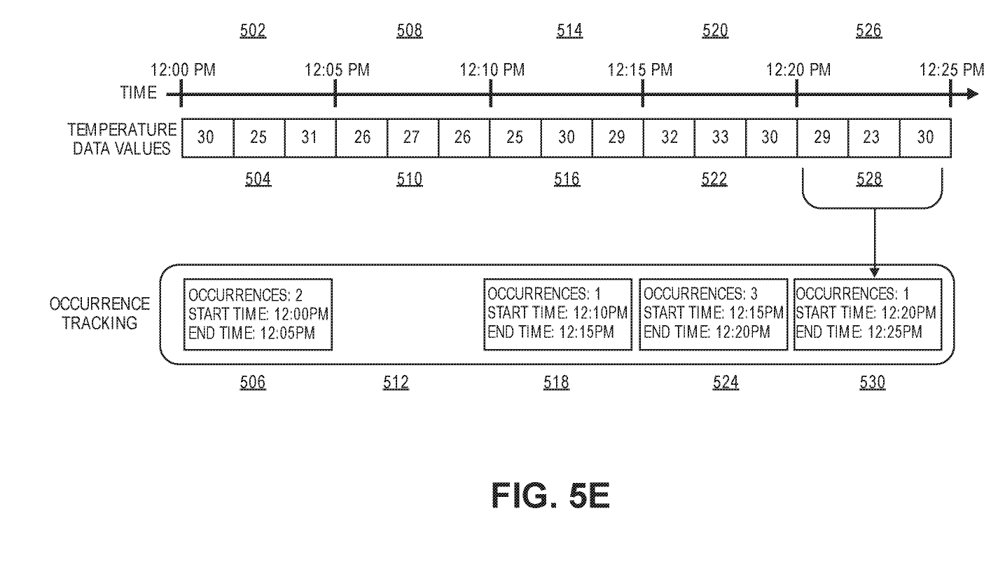

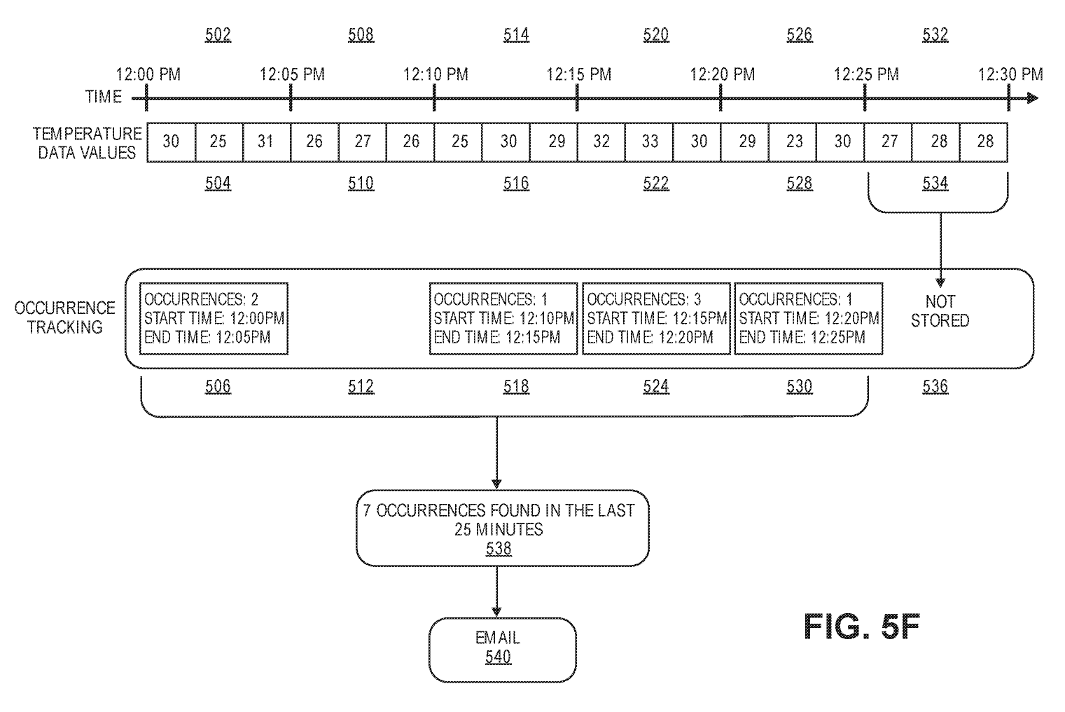

FIGS. 5A-5F show a flow diagram illustrating processing consecutive pluralities of data values. FIGS. 5A-5F will be described in the context of data values related to temperature readings. It is understood, however, that the invention can be applied to other circumstances (e.g., voltage readings, current readings, power readings, chemical readings, density readings, etc.) in which the ability to perform data processing is needed.

FIGS. 5A-5F will also be described in the context of one functional apparatus. The functional apparatus may be a thermometer that measures the temperature of a part of a computer. If the computer part reaches excessive temperatures it may fail. The first predetermined threshold value, in this example, may be predetermined to be 30 degrees. The second predetermined threshold value may be equal to 1, meaning a data point will be stored if at least one temperature measurement is above 30 degrees in a length of time of the data value time window. In this example, the data value time window may be 5 minutes, and the data point time window may be 25 minutes.

FIGS. 5A-5F may be consecutive in time, meaning 5A may occur, then 5B, then 5C, 5D, 5E, and then 5F.

FIG. 5A includes a first data value time window 502, first temperature data values 504, and a first occurrence tracking 506.

In this example, the first data value time window 502 may be five minutes long and may be from “12:00 PM” to “12:05 PM.”

The first temperature data values 504 shows three different data values, “30,” “25,” and “31.” In this example, these three data values have been grouped into a set of data values using the first data value time window 502. The set of data values thus includes 3 data values in the first data value time window 502 of 5 minutes.

The first occurrence tracking 506 shows the data point that has been stored in the occurrence database 114. The first occurrence tracking 506 includes “occurrences,” “start time,” and “end time.”

Between 12:00 PM and 12:05 PM, three temperature data values were measured by the thermometer. The time-slice computer 112 may determine the number of data values in the set of data values that pass the first predetermined threshold value of 30. In this example, the time-slice computer 112 may determine that 2 of the 3 data values of the set of data values are greater than or equal to 30. The data values of 30 and 31 are greater than or equal to the first predetermined threshold value. The data value of 25 is not greater than or equal to the first predetermined threshold value. The number of data values that pass the first predetermined threshold value may be referred to as “occurrences.” The time-slice computer 112 may then create the data point with occurrences equal to “2,” the start time of “12:00 PM,” and the end time of “12:05 PM.”

The time-slice computer 112 may then determine if the number of data values is greater than or equal to the second predetermined threshold value. The time-slice computer 112 may compare the number of data values, 3, to the second predetermined threshold value, 1. Since the number of data values is greater than the second predetermined threshold value, the time-slice computer 112 may store the data point in the occurrence database 114.

FIG. 5B further includes a second data value time window 508, second temperature data values 510, and a second occurrence tracking 512. In this example, the second data value time window 508 may be “12:05 PM” to “12:10 PM.” The second temperature data values 510 may be “26,” “27,” and “28.” The second occurrence tracking 512 may have similar characteristics to the first occurrence tracking 506.

Between 12:05 PM and 12:10 PM three more data values (26, 27, and 28) were measured by the thermometer. The time-slice computer 112 may determine the number of data values in the set of data values that are greater than or equal to “30.” In this example, the time-slice computer 112 may determine that the data values of 26, 27, and 28 are all less than 30. The time-slice computer 112 may determine that 0 of the 3 data values of the set of data values are greater than or equal to 30. The time-slice computer 112 may then create the data point with occurrences equal to “0,” the start time of “12:05 PM,” and the end time of “12:10 PM.”

The time-slice computer 112 may then determine that the number of data values, zero, is less than the second predetermined threshold value of one. The time-slice computer 112 may then determine not to store the data point. The second occurrence tracking 512 shows that the data point is not stored.

FIG. 5C further includes a third data value time window 514, third temperature data values 516, and a third occurrence tracking 518. In this example, the third data value time window 514 may be “12:10 PM” to “12:15 PM.” The third temperature data values 516 may be “25,” “30,” and “29.” The third occurrence tracking 518 may have similar characteristics to the first occurrence tracking 506.

Between 12:10 PM and 12:15 PM three more data values (25, 30, and 29) were measured by the thermometer. The time-slice computer 112 may determine the number of data values in the set of data values that are greater than or equal to “30.” In this example, the time-slice computer 112 may determine that the data value of 30 is equal to the first predetermined threshold of 30. The time-slice computer 112 may determine that 1 of the 3 data values of the set of data values is greater than or equal to 30. The time-slice computer 112 may then create the data point with occurrences equal to “1,” the start time of “12:10 PM,” and the end time of “12:15 PM.”

The time-slice computer 112 may then determine that the number of data values, one, is greater than or equal to the second predetermined threshold value of one. The time-slice computer 112 may then determine to create and store the data point. The third occurrence tracking 518 shows that the data point is stored in the occurrence database 114.

FIG. 5D further includes a fourth data value time window 520, fourth temperature data values 522, and a fourth occurrence tracking 524. In this example, the fourth data value time window 520 may be “12:15 PM” to “12:20 PM.' The fourth temperature data values 522 may be “32,” “33,” and “30.” The fourth occurrence tracking 524 may have similar characteristics to the first occurrence tracking 506.

Between 12:15 PM and 12:20 PM three more data values (32, 33, and 30) were measured by the thermometer. The time-slice computer 112 may determine the number of data values in the set of data values that are greater than or equal to “30.” In this example, the time-slice computer 112 may determine that the data values of 32, 33, and 30 are all greater than or equal to 30. The time-slice computer 112 may determine that 3 of the 3 data values of the set of data values are greater than or equal to 30. The time-slice computer 112 may then create the data point with occurrences equal to “3,” the start time of “12:15 PM,” and the end time of “12:20 PM.”

The time-slice computer 112 may then determine that the number of data values, three, is greater than or equal to the second predetermined threshold value of one. The time-slice computer 112 may then determine to create and store the data point. The fourth occurrence tracking 524 shows that the data point is stored in the occurrence database 114.

FIG. 5E further includes a fifth data value time window 526, fifth temperature data values 528, and a fifth occurrence tracking 530. In this example, the fifth data value time window 526 may be “12:20 PM” to “12:25 PM.” The fifth temperature data values 528 may be “29,” “23,” and “30.” The fifth occurrence tracking 530 may have similar characteristics to the first occurrence tracking 506.

Between 12:20 PM and 12:25 PM three more data values (29, 23, and 30) were measured by the thermometer. The time-slice computer 112 may determine the number of data values in the set of data values that are greater than or equal to “30.” In this example, the time-slice computer 112 may determine that the data value of 30 is equal to the first predetermined threshold value of 30. The time-slice computer 112 may determine that 1 of the 3 data values of the set of data values are greater than or equal to 30. The time-slice computer 112 may then create the data point with occurrences equal to “1,” the start time of “12:20 PM,” and the end time of “12:25 PM.”

The time-slice computer 112 may then determine that the number of data values, one, is greater than or equal to the second predetermined threshold value of one. The time-slice computer 112 may then determine to create and store the data point. The fifth occurrence tracking 530 shows that the data point is stored in the occurrence database 114.

FIG. 5F further includes a sixth data value time window 532, sixth temperature data values 534, a sixth occurrence tracking 536, data monitor computer result 538, and additional processing 540. In this example, the sixth data value time window 532 may be “12:25 PM” to “12:30 PM.” The sixth temperature data values 534 may be “27,” “28,” and “28.” The sixth occurrence tracking 536 may have similar characteristics to the first occurrence tracking 506.

Between 12:25 PM and 12:30 PM three more data values (27, 28, and 28) were measured by the thermometer. The time-slice computer 112 may determine the number of data values in the set of data values that are greater than or equal to “30.” In this example, the time-slice computer 112 may determine that none of the data values are greater than or equal to 30. The time-slice computer 112 may determine that 0 of the 3 data values of the set of data values are greater than or equal to 30. The time-slice computer 112 may then create the data point with occurrences equal to “0,” the start time of “12:25 PM,” and the end time of “12:30 PM.”

The time-slice computer 112 may then determine that the number of data values, zero, is less than to the second predetermined threshold value of one. The time-slice computer 112 may then determine not to store the data point. The sixth occurrence tracking 536 shows that the data point is not stored.

The data monitor computer 116 may analyze the group of data points created by the time-slice computer 112 to determine if a number of data values in the group of data points passes a criteria. In this example, the criteria may be at least 7 data values in a 25 minute period. The data monitor computer 116 may determine that the number of data values in the group of data points, 7, passes the criteria of at least 7 values. The data monitor computer result 538 shows that the data monitor computer has determined that 7 occurrences have been found in the last 25 minutes.

Additional processing 540 shows that, in this example, additional processing may comprise sending an email. The data monitor computer 116 may transmit emails to predetermined addresses. The emails may alert the recipients of the emails that the server computer has reached critical temperatures at least 7 times in the past 25 minutes.

The data monitor computer 116 may then analyze the next group of data points. The next group of data points may be in the data point time window of 12:05 PM to 12:30 PM (25 minutes). The data monitor computer 116 may determine that the total number of data values in the group of data points is 5. The data monitor computer 116 may then determine that the total number of data values does not pass the criteria of at least 7 values. In this case, no additional processing will occur. The data monitor computer 116 may then receive the next group of data points.

In other embodiments, the data monitor computer 116 may analyze the group of data points while the time-slice computer 112 analyzes the sets of data values. For example, the data monitor computer 116 may analyze the group of data points associated with the data point time window of 8:00 AM to 8:30 AM, while the time-slice computer 112 analyzes the set of data values associated with the data value time window of 8:30 AM to 8:35 AM. Subsequently, the data monitor computer 116 may analyze the group of data points associated with the data point time window of 8:05 AM to 8:35 AM.

Other embodiments of the invention may be directed towards functional apparatuses that measure other physical quantities. For example, there may be 4000 functional apparatuses that may be seismometers spread throughout a city. The seismometers may generate pluralities of data values. Each seismometer may transmit the plurality of data values to the data storage computer 108. The plurality of data values from each seismometer may be stored in the data point database 110, and may be associated with a data value time window of 30 seconds. The time-slice computer 112 may receive the plurality of data values and group sets of data values from the plurality of data values. The time-slice computer 112 may determine, for each set of data values, the number of data values that are above a first predetermined threshold value, which in this case may be a certain amount of movement of the Earth. The time-slice computer 112 may then create a data point comprising the number of data values in the set of data values, a start time, and an end time. Then the time-slice computer 112 may store the data point in the occurrence database 114 if the number of data values is above the second predetermined threshold value, which may be the number of times the certain amount of movement of the Earth may occur in the data value time window, this may be one time. Therefore a data point is created if there is more than a predetermined amount of movement in a 30 second period at least once. The data monitor computer 116 may then analyze the group of data points created by the time-slice computer 112 to determine if the total number of data values in the group of data points passes a criteria. In this example, the criteria may be 10 times in 5 minutes. The data monitor computer 116 may then perform additional processing if the total number of data values passes the criteria. For example, the additional processing may be invoking the client devices, e.g. warning sirens, to alert citizens about an earthquake.

Embodiments of the invention provide for a number of advantages. One advantage is that rather than evaluating every data value at once or sequentially, as in previous systems and methods, embodiments of the invention analyze summarized data (i.e., the data points). Analyzing the data points, rather than all of the data values is more processor efficient and thus results in less computation time.

Embodiments of the invention provide near real-time processing of data. In the case of detecting system failures, near real-time processing allows users to determine that a component has failed and immediately fix or replace the failed component. Embodiments of the invention may also provide warning for functional apparatuses that are close to failure. They may then be replaced before the failure occurs.

Another advantage is that data values from many functional apparatuses can be processed at the same time. Embodiments of the invention allow for the determination if one of many hundred functional apparatuses have failed.

Further, the data values from all of the functional apparatuses may be grouped together into a set of data values, rather than grouped into different sets of data values through the use of the device identifier. As such, embodiments of the invention provide for the advantage of evaluating data from many functional apparatuses at a location, such as a hospital, thus allowing for a near real-time evaluation of the hospital's functional apparatuses as a whole. An example use case of this may be power outages affecting all of the voltages of functional apparatuses at the hospital. Embodiments of the present invention have the advantage of detecting these power outages at a large scale through the use of many different functional apparatuses.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
a) receiving, by one or more data processors, a plurality of data values generated by one or more functional apparatuses, the plurality of data values being ordered by a time when the data values in the plurality of data values were generated by the one or more functional apparatuses;
b) grouping, by the one or more data processors, sets of data values from the plurality of data values using a data value time window;
c) for each set of data values, (i) determining, by the one or more data processors, a number of data values in the set of data values that pass a first predetermined threshold value, (ii) creating a data point comprising the number of data values in the set of data values, and a start time associated with the data value time window, and an end time associated with the data value time window, and (iii) storing, in an occurrence database, the data point when the number of data values in the data point pass a second predetermined threshold value;
d) analyzing, by the one or more data processors, a group of data points created in step c) to determine if a total number of data values in the group of data points pass a criteria; and
e) performing, by the one or more data processors, additional processing, if the total number of data values passes the criteria.

2. The method of claim 1, wherein steps a), b), and c) are performed by a first processor in a time-slice computer, and steps d), and e) are performed by a second processor in a data monitor computer.

3. The method of claim 1, wherein the functional apparatuses include server computers, laboratory instruments, measurement devices, thermometers, voltmeters, ammeters, wattmeters, chemical monitors, hydrometers, and heart rate monitors.

4. The method of claim 1, wherein the data values comprise temperature readings, voltage readings, current readings, power readings, chemical readings, and density readings.

5. The method of claim 1, wherein additional processing comprises transmitting alert messages to one or more client devices, creating a work order ticket, creating a maintenance order, creating a repair order, and calling one or more client devices.

6. The method of claim 5, wherein the one or more client devices are the one or more functional apparatuses, and wherein additional processing comprises shutting down the one or more functional apparatuses, changing a data measurement rate of the one or more functional apparatuses, and changing parameters of the one or more functional apparatuses.

7. The method of claim 1, wherein the one or more functional apparatuses is only one functional apparatus.

8. The method of claim 1, wherein the one or more functional apparatuses comprises two or more functional apparatuses.

9. The method of claim 8, wherein the data values of the plurality of data values are associated with a device identifier, and wherein a set of data values of the sets of data values includes data values associated with a single device identifier.

10. The method of claim 8, wherein the data values of the plurality of data values are associated with a device identifier, and wherein a set of data values of the sets of data values include data values associated with many device identifiers.

11. A system comprising:
one or more data processors; and
one or more computer readable media coupled to the one or more processors, the one or more computer readable media comprising code executable by the one or more processors to perform a method comprising:
a) receiving, a plurality of data values generated by one or more functional apparatuses, the plurality of data values being ordered by a time when the data values in the plurality of data values were generated by the one or more functional apparatuses;
b) grouping, sets of data values from the plurality of data values using a data value time window;
c) for each set of data values, (i) determining, a number of data values in the set of data values that pass a first predetermined threshold value, (ii) creating a data point comprising the number of data values in the set of data values, and a start time associated with the data value time window, and an end time associated with the data value time window, and (iii) storing, in an occurrence database, the data point when the number of data values in the data point pass a second predetermined threshold value;
d) analyzing, a group of data points created in step c) to determine if a total number of data values in the group of data points pass a criteria; and
e) performing, additional processing, if the total number of data values passes the criteria.

12. The system of claim 11, wherein steps a), b), and c) are performed by a first processor in a time-slice computer, and steps d), and e) are performed by a second processor in a data monitor computer.

13. The system of claim 11, wherein the functional apparatuses include server computers, laboratory instruments, measurement devices, thermometers, voltmeters, ammeters, wattmeters, chemical monitors, hydrometers, and heart rate monitors.

14. The system of claim 11, wherein the data values comprise temperature readings, voltage readings, current readings, power readings, chemical readings, and density readings.

15. The system of claim 11, wherein additional processing comprises transmitting alert messages to one or more client devices, creating a work order ticket, creating a maintenance order, creating a repair order, and calling one or more client devices.

16. The system of claim 15, wherein the one or more client devices are the one or more functional apparatuses, and wherein additional processing comprises shutting down the one or more functional apparatuses, changing a data measurement rate of the one or more functional apparatuses, and changing parameters of the one or more functional apparatuses.

17. The system of claim 11, wherein the one or more functional apparatuses is only one functional apparatus.

18. The system of claim 11, wherein the one or more functional apparatuses comprises two or more functional apparatuses.

19. The system of claim 18, wherein the data values of the plurality of data values are associated with a device identifier, and wherein a set of data values of the sets of data values includes data values associated with a single device identifier.

20. The system of claim 19, wherein the data values of the plurality of data values are associated with a device identifier, and wherein a set of data values of the sets of data values include data values associated with many device identifiers.
